(19) United States
(12) Patent Application Publication
(10) Pub. No.: US 2025/0214647 A1
(43) Pub. Date: Jul. 3, 2025

(54) OPERATOR ENGAGEMENT BASED VEHICLE COMPONENT ACTUATION

(71) Applicant: Ford Global Technologies, LLC, Dearborn, MI (US)

(72) Inventors: Mahmoud Yousef Ghannam, Canton, MI (US); Justin Miller, Berkley, MI (US)

(73) Assignee: Ford Global Technologies, LLC, Dearborn, MI (US)

(21) Appl. No.: 18/401,968

(22) Filed: Jan. 2, 2024

(51) Int. Cl. B62D 6/00; B60K 35/65; B60K 35/80; G06F 3/01; G06V 20/59

(52) U.S. Cl. CPC B62D 6/00; G06F 3/013; G06V 20/593; G06V 20/597; B60K 35/654; B60K 35/80

(57) ABSTRACT

A system includes a computer having a processor and a memory. The memory storing instructions executable by the processor to determine a presence of a passenger, determine an eye gaze direction of an operator based on an image of the operator, and determine a location of a hand of the operator based on the image of the operator. The system actuates a vehicle component based on the determined presence of the passenger, the determined eye gaze direction of the operator, and the determined location of the hand of the operator.

### BACKGROUND

A vehicle can include a human machine interface (HMI), such as a touch screen display associated with, e.g., one or more of an infotainment system, a vehicle navigation system, and/or a communication system. A user, such as a passenger in the vehicle, can provide input to these systems via the HMI. When the vehicle is in motion, the HMI can be disabled with respect to certain systems and/or features of those systems.

### BRIEF DESCRIPTION OF THE DRAWINGS

FIG. 1 is a block diagram of an example vehicle.

FIG. 2A is an example camera view of an operator seated in a vehicle.

FIG. 2B is an example nodal model of the operator of FIG. 2A.

FIG. 3 is an example vehicle interior within an operator field of view.

FIG. 4 is a process flow diagram illustrating an example process for operator engagement based vehicle component actuation.

### DETAILED DESCRIPTION

This disclosure provides techniques for controlling vehicle components, features, and/or systems in response to determining whether an operator's hands are in contact with a vehicle steering wheel and the operator's gaze is in a forward direction with respect to the vehicle, e.g., toward a road. In an example, a touch screen display associated with, e.g., one or more of an infotainment system, a vehicle navigation system, and/or a communication system can be enabled to interact with a vehicle passenger in response to a determination that the operator's hands are in contact with the steering wheel and the operator's gaze is on the road. In some examples, enabling the touch screen is further contingent on the presence of a passenger. In an example, other or additional components of the vehicle can be actuated in addition to or in lieu of the touch screen display. For example, a steering component can be actuated when the operator's hands are not in contact with the steering wheel and/or the operator's gaze direction is away from the road. In examples, a camera mounted on a dashboard of the vehicle, and/or other sensors, can obtain images that may include an operator positioned in the driver's seat of the vehicle. These images can be used to determine an eye gaze direction of an operator and locations of the operator's hands. Certain portions of the operator, e.g., one or more of the operator's hands, forearms, etc., may not be visible within the camera field-of-view. A computer can execute programming utilizing the images to construct a nodal model of the operator. The computer can additionally estimate locations of features of the operator that are obscured from the camera's field-of-view. The computer can estimate the operator's eye gaze direction based on the images. The gaze direction can be estimated using eye tracking algorithms, for example. The gaze direction can then be mapped to zones associated with the windshield and dashboard to indicate if the operator is looking at the road or other location in the interior of the vehicle, such as the infotainment system, vehicle navigation system, and/or communication system.

Disclosed herein is a system including a computer having a processor and a memory. The memory includes instructions executable by the processor to determine a presence of a passenger, determine an eye gaze direction of an operator based on an image of the operator, and determine a location of a hand of the operator based on the image of the operator. The system actuates a vehicle component based on the determined presence of the passenger, the determined eye gaze direction of the operator, and the determined location of the hand of the operator.

The vehicle component can be a steering component of a vehicle and the instructions can include instructions to actuate the steering component when the location of the hand is not in contact with a steering element of the vehicle and the eye gaze direction is away from a forward direction with respect to the vehicle.

The vehicle component can be a human machine interface (HMI) of a vehicle and the instructions can include instructions to enable the HMI when the passenger is present, the location of the hand is in contact with a steering element of the vehicle, and the eye gaze direction is in a forward direction with respect to the vehicle.

The instructions can include instructions to disable the HMI when the location of the hand is not in contact with the steering element of the vehicle, or the eye gaze direction is not in the forward direction.

The instructions to determine an eye gaze direction can include instructions to utilize the image of the operator to determine a gaze angle and map the gaze angle to a direction with respect to a vehicle.

The instructions to determine a location of a hand of the operator can include instructions to utilize the image of the operator to construct a nodal model of the operator.

The instructions can include instructions to determine an eye gaze direction of the passenger based on an image of the passenger and determine a location of a hand of the passenger based on the image of the passenger.

The vehicle component can be a HMI of a vehicle and the instructions can include instructions to enable the HMI when the passenger is present, the location of the operator's hand is in contact with a steering element of the vehicle, the operator's eye gaze direction is in a forward direction with respect to the vehicle, the passenger's eye gaze direction is toward the HMI, and the location of the passenger's hand is in contact with the HMI. The instructions can include instructions to disable the HMI when the passenger is not present. The HMI can be a vehicle navigation system.

Disclosed herein is a method including determining a presence of a passenger, determining an eye gaze direction of an operator based on an image of the operator, and determining a location of a hand of the operator based on the image of the operator. The method can include actuating a vehicle component based on the determined presence of the passenger, the determined eye gaze direction of the operator, and the determined location of the hand of the operator.

The vehicle component can be a steering component of a vehicle and the method can include actuating the steering component when the location of the hand is not in contact with a steering element of the vehicle and the eye gaze direction is away from a forward direction with respect to the vehicle.

The vehicle component can be a human machine interface (HMI) of a vehicle and the method can include enabling the HMI when the passenger is present, the location of the hand is in contact with a steering element of the vehicle, and the eye gaze direction is in a forward direction with respect to the vehicle.

The method can include disabling the HMI when the location of the hand is not in contact with the steering element of the vehicle, or the eye gaze direction is not in the forward direction.

Determining an eye gaze direction can include utilizing the image of the operator to determine a gaze angle and map the gaze angle to a direction with respect to a vehicle.

Determining a location of a hand of the operator can include utilizing the image of the operator to construct a nodal model of the operator.

The method can include determining an eye gaze direction of the passenger based on an image of the passenger and determining a location of a hand of the passenger based on the image of the passenger.

The vehicle component can be a HMI of a vehicle and the method can include enabling the HMI when the passenger is present, the location of the operator's hand is in contact with a steering element of the vehicle, the operator's eye gaze direction is in a forward direction with respect to the vehicle, the passenger's eye gaze direction is toward the HMI, and the location of the passenger's hand is in contact with the HMI. The method can include disabling the HMI when the passenger is not present. The HMI can be a vehicle navigation system.

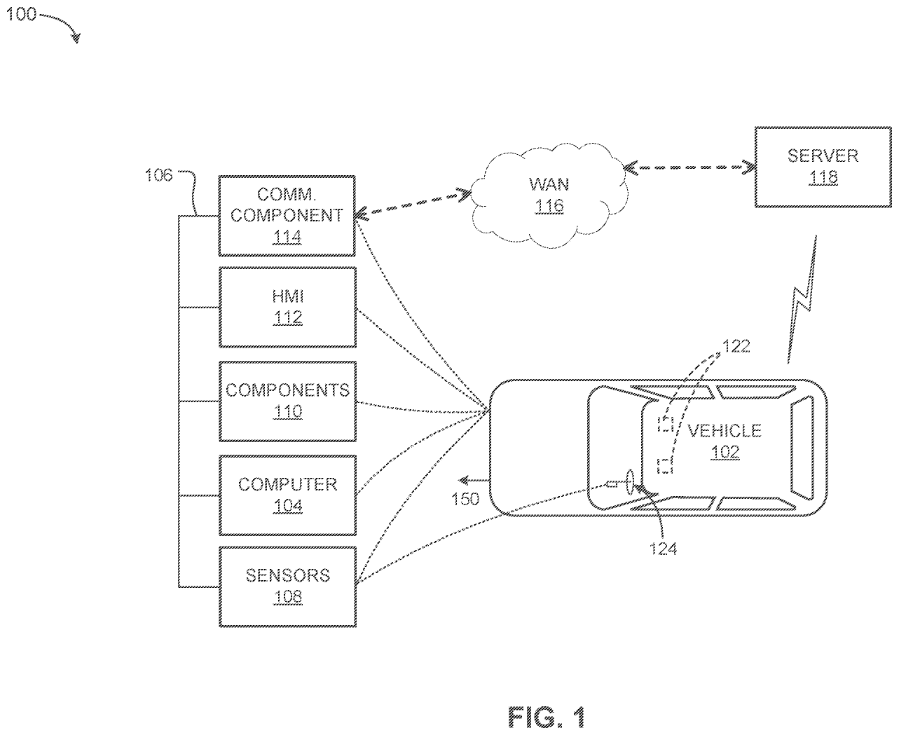

FIG. 1 is a block diagram of an example vehicle. As shown in FIG. 1, system 100 includes vehicle 102, that includes computer 104 that is communicatively coupled, via vehicle network 106, to various elements including sensors 108, subsystems or components 110, such as steering, propulsion, braking, human machine interface (HMI) 112, and communication component 114. Computer 104, and server 118 discussed below, include a processor and a memory. A memory of computer 104, such as those described herein, includes one or more forms of non-transitory media readable by computer 104, and can store instructions executable by computer 104 for performing various operations, such that the vehicle computer is configured to perform the various operations, including those disclosed herein.

For example, computer 104 can include a generic computer with a processor and memory as described above and/or may comprise an electronic control unit (ECU) or a controller for a specific function or set of functions, and/or a dedicated electronic circuit including an ASIC (application specific integrated circuit) that is manufactured for a particular operation, (e.g., an ASIC for processing data from sensors and/or communicating data from sensors 108). In another example, computer 104 may include an FPGA (Field-Programmable Gate Array), which is an integrated circuit manufactured to be configurable by a user. In examples, a hardware description language such as VHDL (Very High-Speed Integrated Circuit Hardware Description Language) may be used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g., stored in a memory electrically connected or coupled to the FPGA circuit. In some examples, a combination of processor(s), ASIC(s), and/or FPGA circuits may be included in computer 104. Further, computer 104 may include a plurality of computers in the vehicle (e.g., a plurality of ECUs or the like) operating together to perform operations ascribed herein to the computer 104.

A memory of computer 104 can include any type, such as hard disk drives, solid state drives, or any volatile or non-volatile media. The memory can store the collected data transmitted by sensors 108. The memory can be a separate device from computer 104, and computer 104 can retrieve information stored by the memory via a communication network in the vehicle such as vehicle network 106, e.g., over a controller area network (CAN) bus, a local interconnect network (LIN) bus, a wireless network, etc. Alternatively or additionally, the memory can be part of computer 104, for example, as a memory internal to computer 104.

Computer 104 can include or access instructions to operate one or more components 110 such as vehicle brakes, propulsion (e.g., one or more of an internal combustion engine, electric motor, hybrid engine, etc.), steering, climate control, interior and/or exterior lights, infotainment, navigation etc., as well as to determine whether and when computer 104, as opposed to a human operator, is to control such operations. Computer 104 can include or be communicatively coupled, e.g., via vehicle network 106, to more than one processor, which can be included in components 110 such as sensors 108, ECUs or the like included in the vehicle for monitoring and/or controlling various vehicle components, e.g., a powertrain controller, a brake controller, a steering controller, etc.

Computer 104 may be generally arranged for communications on vehicle network 106 that can include a communications bus in the vehicle, such as a controller area network CAN or the like, and/or other wired and/or wireless mechanisms. Vehicle network 106 corresponds to a communications network, which can facilitate exchange of messages between various onboard vehicle devices, e.g., sensors 108, components 110, computer 104 and a computer onboard vehicle 102. Computer 104 can be generally programmed to send and/or receive, via vehicle network 106, messages to and/or from other devices in vehicle, e.g., any or all of ECUs, sensors 108, actuators, components 110, communications module, HMI 112. For example, various component 110 subsystems (e.g., components 110) can be controlled by respective ECUs.

Further, in implementations in which computer 104 actually comprises a plurality of devices, vehicle network 106 may be used for communications between devices represented as computer 104 in this disclosure. For example, vehicle network 106 can provide a communications capability via a wired bus, such as a CAN bus, a LIN bus, or can utilize any type of wireless communications capability. Vehicle network 106 can include a network in which messages are conveyed using any other wired communication technologies and/or wireless communication technologies, e.g., Ethernet, Wi-Fi®, Bluetooth®, etc. Additional examples of protocols that may be used for communications over vehicle network 106 in some implementations include, without limitation, Media Oriented System Transport (MOST), Time-Triggered Protocol (TTP), and FlexRay. In some implementations, vehicle network 106 can represent a combination of multiple networks, possibly of different types, that support communications among devices onboard a vehicle. For example, vehicle network 106 can include a CAN bus, in which some in-vehicle sensors and/or components communicate via a CAN bus, and a wired or wireless local area network in which some device in vehicle communicate according to Ethernet, Wi-Fi®, and/or Bluetooth communication protocols.

Vehicle 102 typically includes a variety of sensors 108 including torque sensors, capacitive sensors, and other sensors related to determining whether an operator has placed a hand into contact with steering wheel 124. Sensors 108 can include a suite of devices that can obtain one or more measurements of one or more physical phenomena. Some of sensors 108 detect variables that characterize the operational environment of the vehicle, e.g., vehicle speed settings, vehicle towing parameters, vehicle braking parameters, engine torque output, engine and transmission temperatures, battery temperatures, vehicle steering parameters, etc. Some of sensors 108 detect variables that characterize the physical environment of vehicle 102, such as ambient air temperature, humidity, weather conditions (e.g., rain, snow, etc.), parameters related to the inclination or gradient of a road or other type of path on which the vehicle is proceeding, etc. In examples, sensors 108 can operate to detect the position or orientation of the vehicle utilizing, for example, signals from a satellite positioning system (e.g., global positioning system or GPS); accelerometers, such as piezo-electric or microelectromechanical systems MEMS; gyroscopes such as rate, ring laser, or fiber-optic gyroscopes; inertial measurement units IMU; and magnetometers. In examples, sensors 108 can include sensors to detect aspects of the environment external to vehicle 102, such as radar sensors, scanning laser range finders, cameras, etc. Sensors 108 can also include light detection and ranging (LIDAR) sensors, which operate to detect distances to objects by emitting a laser pulse and measuring the time of flight for the pulse to travel to the object and back. Sensors 108 may include a controller and/or a microprocessor, which execute instructions to perform, for example, analog-to-digital conversion to convert sensed analog measurements and/or observations to input signals that can be provided to computer 104, e.g., via vehicle network 106.

Sensors 108 may include occupancy sensors 122 to identify whether an occupant is seated in one or more of the seats. The occupancy sensor 122 may be, for example, a weight sensor, image detection, a buckled seatbelt, etc. The vehicle 102 may include any suitable number of occupancy sensors 122. For example, the vehicle 102 may include a number of occupancy sensors 122 equal to the number of seats in the vehicle 102, including e.g., operator and front seat passenger seats. In some examples, the occupancy sensors 122 may be of a conventional type currently known in the art.

Computer 104 can be configured for utilizing vehicle-to-vehicle (V2V) communications via communication component 114 and/or may interface with devices outside of the vehicle, e.g., through wide area network (WAN) 116 via V2V communications. Computer 104 can communicate outside of vehicle 102, such as via vehicle-to-infrastructure (V2I) communications, vehicle-to-everything (V2X) communications, or V2X including cellular communications C-V2X, and/or wireless communications cellular dedicated short-range communications DSRC, etc. Communications outside of vehicle 102 can be facilitated by direct radio frequency communications and/or via network server 118. Communications component 114 can include one or more mechanisms by which computer 104 communicates with vehicles outside of vehicle 102, including any desired combination of wireless, e.g., cellular, wireless, satellite, microwave, radio frequency communication mechanisms and any desired network topology or topologies when a plurality of communication mechanisms are utilized.

Vehicle 102 can include HMI 112, e.g., one or more of an infotainment display, a touchscreen display, a microphone, a speaker, a haptic device, etc. A user, such as the operator and/or a passenger of vehicle 102, can provide input to devices such as computer 104 via HMI 112. HMI 112 can communicate with computer 104 via vehicle network 106, e.g., HMI 112 can send a message including the user input provided via a touchscreen, microphone, a camera that captures a gesture, etc., to computer 104, and/or can display output, e.g., via a display, speaker, etc. Further, operations of HMI 112 can be performed by a portable user device (not shown) such as a smart phone or the like in communication with computer 104, e.g., via Bluetooth or the like.

WAN 116 can include one or more mechanisms by which computer 104 may communicate with server 118. Server 118 can include an apparatus having one or more computing devices, e.g., having respective processors and memories and/or associated data stores, which may be accessible via WAN 116. In examples, vehicle 102 could include a wireless transceiver (i.e., transmitter and/or receiver) to send and receive messages outside of vehicle 102. Accordingly, the network can include one or more of various wired or wireless communication mechanisms, including any desired combination of wired e.g., cable and fiber and/or wireless, e.g., cellular, wireless, satellite, microwave, and radio frequency communication mechanisms and any desired network topology or topologies when multiple communication mechanisms are utilized. Exemplary communication networks include wireless communication networks, e.g., using Bluetooth, Bluetooth Low Energy BLE, IEEE 802.11, V2V or V2X such as cellular V2X CV2X, DSRC, etc., local area networks and/or wide area networks 116, including the Internet.

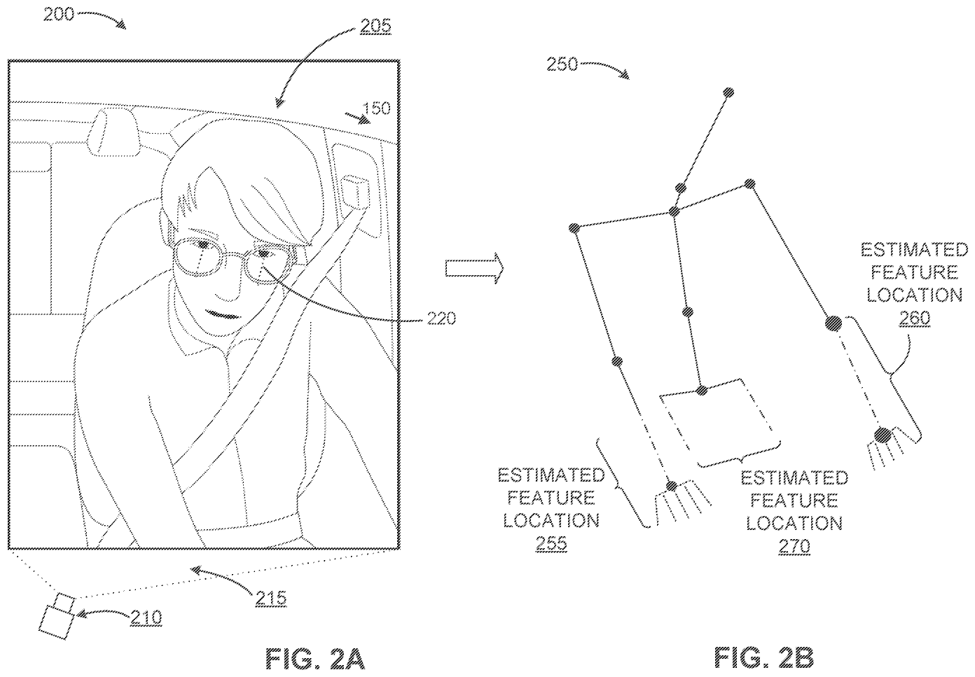

In an example, computer 104 can obtain an image of a portion of a vehicle 102 interior that may include an operator seated in the driver's seat of vehicle 102 utilizing a camera 210 (FIG. 2A) mounted on the dashboard of the vehicle 102. In some examples, the image of the operator 205 includes the operator's head, neck, shoulders, chest, and/or upper arms, for example, but may exclude an image of the operator's hands. Accordingly, suitable image processing programming executed by computer 104 can extract parameters of the image to form a nodal model (discussed further below with respect to FIG. 2B) of the portion of the operator's body that lies within the camera's field of view 215. Computer 104 can additionally execute programming to estimate the locations of features excluded or obscured from the field-of-view of the camera.

Computer 104 can further execute programming to determine a level of confidence as to whether the nodal model of the operator is consistent with a nodal model of an operator with one or more hands placed into contact with the steering wheel 124. Responsive to the confidence level meeting a predetermined threshold (e.g., greater than 95%) that the operator's hand(s) are at a location on the steering wheel, computer 104 may execute programming to actuate or generate a signal to indicate that one or more of the operator's hands are in contact with steering wheel 124. Conversely, responsive to the confidence level being below the predetermined threshold, computer 104 can execute programming to actuate or generate a signal to indicate that one or more of the operator's hands are not in contact with steering wheel 124. It is noted that although FIG. 1 shows a steering wheel 124, techniques described herein can apply to steering components other than a steering wheel of a vehicle, such as a joystick, an aircraft control yoke, etc.

A computer can include programming to determine the presence of a passenger, i.e., a person other than an operator or driver and hence seated in a position other than in an operator or driver position. When a passenger is present the computer then determines if the operator is fully engaged in the operation of the vehicle, i.e., hands on the steering wheel and eye gaze on the road. The computer can determine an eye gaze direction of the operator and locations of the operator's hands based on an image of the operator. The computer can then actuate a vehicle component (e.g., vehicle HMI) based on the determined presence of the passenger, the determined eye gaze direction of the operator, and the determined locations of the hands of the operator.

FIG. 2A is an example camera view 200 of operator 205 seated in vehicle 102. The camera view of FIG. 2A may be obtained via dashboard mounted camera 210 of vehicle 102, which may be positioned near a center portion of the dashboard of vehicle 102. Dashboard mounted camera 210 can provide field-of-view 215 that includes operator 205 in a steering position of the vehicle and a passenger to the right of operator 205, as well as passengers located behind operator 205. Dashboard mounted camera 210 may include any camera imaging device capable of detecting electromagnetic radiation in a range of wavelengths. For example, dashboard mounted camera 210 may detect visible light, infrared radiation, ultraviolet light, or some range of wavelengths including visible, infrared, and/or ultraviolet light. For example, a dashboard mounted camera can include image sensors such as charge-coupled devices (CCD), active-pixel sensors such as complementary metal-oxide semiconductor (CMOS) sensors, etc. In some examples, images captured by dashboard mounted camera 210 may be complemented or augmented by additional non-camera sensors of sensors 108. In some examples, images captured by dashboard mounted camera 210 may be complemented and/or fused with images captured by other cameras of vehicle 102. Alternatively, or in addition, images of operator 205, which may be fused with or complemented by images from other cameras of vehicle 102, may be fused with depth measurements and/or velocity measurements indicating movements of operator 205 based on signals from a dashboard mounted radar.

As seen in FIG. 2A, operator 205 appears to have an eye gaze direction 220 away from a forward direction 150 with respect to vehicle 102, so as to view and/or interact with an HMI 112 of the vehicle, e.g., infotainment display, a vehicle navigation system, and/or a communication system, etc. In this context, a “forward direction” means the operator's gaze is deemed to be in a direction consistent with being engaged in operating the vehicle. A forward direction could be defined as an area or space with respect to a vehicle coordinate system; for example, a longitudinal axis of a vehicle could be specified in a coordinate system, and then the forward direction could be defined by a cone described by a line at a specified angle to the longitudinal axis. Alternatively or additionally, the operator's gaze could be in a forward direction 150 when looking through the windshield at the road ahead. Yet further alternatively or additionally, a forward direction 150 could be defined by an area of a rearview mirror, side-view mirror, instrument cluster, etc. Further, the forward direction could be defined dynamically, i.e., could change or be different at different times based on vehicle circumstances and/or current operations. For example, a forward direction 150 could be defined as being through a vehicle windshield unless a steering angle of the vehicle exceeds a threshold, whereupon a forward direction could be defined as being through or including a vehicle side window, e.g., when turning a corner. The operator's eye gaze being “away” from the forward direction means that the operator's eye gaze deviates from the forward direction by more than a specified angle and/or does not fall within a space or area (e.g., a cone or other field of view, an area defined by a windshield, etc.) that defined the forward direction. A non-forward direction or away from the forward direction further typically has the consequence that the operator's eye gaze direction is deemed to not be consistent with being engaged with operating the vehicle, such as looking at the HMI 112 of the vehicle 102, e.g., infotainment display, a vehicle navigation system, and/or a communication system, etc.

As also seen in FIG. 2A, operator 205 has dipped their right shoulder in a manner that may be consistent with interacting with a dashboard mounted control of vehicle 102. As yet further seen in FIG. 2A, the hand positions of operator 205 are obscured from view of dashboard mounted camera 210. However, detection of whether operator 205 has placed one or more hands into contact with steering wheel 124 of vehicle 102 can be estimated by way of additional processing, such as by way of image processing and other programming of computer 104 as described further below.

FIG. 2B is an example nodal model 250 of operator 205 of FIG. 2A. In this context, a “nodal model” means a representation of operator 205 by a system of nodes connected by lines so that the nodal model 250 can represent body parts or features of operator 205. Thus, in the example of FIG. 2B, an image of operator 205 may be represented by nodes (solid circles in FIG. 2B) representing shoulders, elbows, hips, etc., of the operator 205, wherein lines are drawn to connect the nodes to represent such features. Nodal model 250 can be generated utilizing a suitable skeletonization technique that operates to reduce captured images to, for example, one-pixel wide representations. In this context, a “skeletonization” technique means representing features of the operator 205 in the image by a nodal model just described. Thus, in FIG. 2B, a skeletonization technique has been applied to operator 205, so as to represent features of operator 205 by nodal model 250. In an example, image processing programming of computer 104 may skeletonize an image of operator 205 by making successive passes of the image obtained by the dashboard mounted camera 210. In accordance with a skeletonization algorithm, during successive frame-by-frame image processing operations, border pixels can be identified and removed from a current image frame based on whether the border pixels of the current image frame break connectivity with an image frame represented by the remaining pixels of the image in a subsequent frame. Accordingly, based on the image processing programming determining that all, or substantially all, pixels remaining in a current frame retain their connectivity with an image from a previous frame, nodal model 250 can be generated.

Responsive to generating nodal model 250, computer 104 can execute programming to determine whether the nodal model is consistent with a nodal model of an operator having one or more hands in contact with, e.g., resting on, steering wheel 124. For example, computer 104 may utilize a measure of an angle of a line drawn between nodes representing the shoulders of operator 205. Alternatively, or in addition, computer 104 may utilize a measure of an angle between a line drawn between nodes representing the shoulders of operator 205 and a line representing an upper arm of the operator. Alternatively, or in addition, computer 104 may utilize a measure of an angle between a line representing an upper arm of operator 205 and the operator's lower arm. Alternatively, or in addition, computer 104 may utilize a distance between a line representing an upper arm of operator 205 and a point on a line drawn between nodes representing the shoulders of operator 205. Computer 104 may utilize additional parameters of nodal model 250 in determining whether the nodal model is consistent with a nodal model of an operator having one or more hands in contact with steering wheel 124.

In an example, programming of the computer 104 to determine whether the generated nodal model 250 is consistent with the nodal model of an operator having a hand or hands in contact with the steering wheel may include a machine-learning technique, e.g., a neural network, capable of predicting whether one or more hands of operator 205 are in contact with, e.g., resting on, steering wheel 124 based on nodal model 250. For example, a neural network could be trained to receive an image of operator 205, aggregated with additional data, such as data from other cameras/sensors in the interior of vehicle 102, describing the position and movements of the operator. The neural network could predict the skeletonization model, confidence, and hands-on-wheel status. The predicted skeletonization model confidence, e.g., hands-on-wheel status, etc., can be compared with actual instances of operator 205 having one or more hands in contact with steering wheel 124. In an example, data can be collected and designated as ground truth data that is utilized to train the neural network and/or to train another machine learning technique. Responsive to initial training of a machine-learning implementation, cross correlation and/or time series analyses could be utilized to determine whether a machine-learning implementation is consistent and/or correlated over a time window, such as a time window during which operator 205 intermittently places hands into contact with steering wheel 124.

In some examples, programming of computer 104 performs a comparison of nodal model 250 with nodal models of an operator known to have one or more hands placed into contact with steering wheel 124. Such reference nodal models, or parameters derived from nodal models, can be stored in a memory accessible to computer 104. In such instances, nodal models of an operator with one or more hands in contact with steering wheel 124 can be compared with nodal models of an operator without one or more hands distant from the steering wheel. For example, a nodal model of an operator with a hand placed into contact with steering wheel 124 may exhibit a particular angle, or range of angles, between a line representing an upper arm and a line drawn between nodes representing the shoulders of the operator. Thus, in response to nodal model 250 exhibiting a similar angle between a line representing an upper arm of operator 205 and a line drawn between nodes representing the shoulders of operator 205, computer 104 may determine a level of confidence that at least one hand of operator 205 is in contact with steering wheel 124.

In an example, computer 104 can execute programming to estimate a location or locations of one or more hands or other features of operator 205 based on comparisons with nodal models, e.g., nodal models derived from images of operators similar to operator 205 (e.g., approximately the same torso and/or arm length), stored in a memory of computer 104. In an example, computer 104 can define a coordinate system, e.g., a three-dimensional (3D) Cartesian coordinate system with a specified origin and orthogonal X, Y, and Z axes, for the interior of vehicle 102. The coordinate system can be used to describe attributes of camera 210, such as camera pose, focal depth, etc. Further, defining a coordinate system for the interior of vehicle 102 can allow computer 104 to specify locations of the nodes of nodal model 250 with respect to the defined coordinate system. For example, responsive to determining that a line representing an upper arm portion of operator 205 slopes in a direction towards the base of the driver's seat, as seen in FIG. 2B, computer 104 can estimate the position of the right forearm and hand of operator 205 based on comparisons with nodal models stored in a memory of computer 104. In another example, also as seen in FIG. 2A, the node representing the left elbow of operator 205 is below the node representing the left shoulder of the operator. Accordingly, computer 104 can estimate the location of the left forearm and left hand of operator 205 based on comparisons with nodal models stored in a memory of computer 104.

In some examples, programming of computer 104 may implement a suitable learning model of operator 205 that refines, over a period of time, estimations of whether the hands of operator 205 are in contact with steering wheel 124. For example, a learning model may include use of a nodal model that includes a node representing the head position relative to other nodes of operator 205, an eye gaze direction of the operator, other locations of nodes representing the arms of operator 205, and so forth.

In an example, nodal models of operators known to have one or more hands placed into contact with steering wheel 124 (which may be referred to as reference models) may be stored in a memory accessible to computer 104. Determination of whether nodal model 250 is consistent with a reference nodal model of an operator known to have one or more hands placed into contact with steering wheel 124 can be the result of applying a suitable supervised machine learning process, such as via server 118, which can utilize a corpus of nodal models representing operators having one or more hands in contact with, or (conversely) one or more hands separated from, steering wheel 124. In another example, a suitable unsupervised machine learning technique may be utilized, such as a generative adversarial network, which executes unsupervised development and/or refinement of a process of determining whether one or more hands of operator 205 are in contact with steering wheel 124. Thus, for example, during an unsupervised training process, programming steps executed by computer 104 and/or server 118 can generate nodal models of operators having hands placed into contact (e.g., “hands on”), or, conversely, separated from (e.g., “hands off”), steering wheel 124. Such nodal models can be evaluated and/or reviewed by programming of computer 104 without the benefit of obtaining an advanced indication of the hands on/hands off state of the generated nodal models. Responsive to computer 104 inaccurately identifying a hands on/hands off state of operator 205, one or more parameters of a generated nodal model can be modified. In response to modification of parameters of a nodal model, the generative adversarial network may present the same or similar nodal model for review by computer 104. Accordingly, in an example training environment, which may be hosted by server 118 cooperating with computer 104, the generative adversarial network can iteratively repeat a process of generating of a nodal model, followed by attempted hands-on/hands off detection by programming of computer 104, refinement of parameters of a nodal model, generation of another nodal model, etc.

Computer 104 can then execute programming to determine a level of confidence that estimated feature locations of an operator, e.g., estimated feature locations 255, 260, accord with feature locations of an operator with a hand (or hands) placed into contact with steering wheel 124. In this context, a “level of confidence” or “confidence level” means a degree to which nodal model 250 agrees with a nodal model known to represent an operator having one or more hands placed into contact with steering wheel 124. Thus, for example, a perfect agreement between nodal model 250 and a nodal model, stored in a memory accessible to computer 104, of an operator known to have one or more hands in contact with steering wheel 124 can be assigned a level of confidence of 100%. In another example, a significant disagreement between nodal model 250 and a nodal model stored or accessible to computer 104 can be assigned a lower level of confidence, such as 80%, 75%, etc.

Also in this context, an “estimated feature location” means a predicted location of a limb of operator 205 that is excluded or obscured from view of camera 210 based on observed locations of the features of operator 205 represented by nodal model 250. For example, as seen in FIG. 2B, estimated feature location 255, which corresponds to the right forearm and hand of operator 205, lies nearby estimated feature location 270, which represents the legs of operator 205. Thus, programming of computer 104 may assign a relatively low level of confidence that the right hand of operator 205 is in contact with steering wheel 124. In another example, also as seen in FIG. 2B, estimated feature location 260, which corresponds to the left forearm and hand of operator 205, is positioned, e.g., in the coordinate system of the interior of vehicle 102, at a location that approaches steering wheel 124. Thus, computer 104 may assign a relatively high level of confidence that the left hand of operator 205 is in contact with steering wheel 124.

In an example for a machine learning model implementing a neural network, a confidence level can be increased utilizing a Bayesian neural network or an ensemble approach in which the variance in a confidence level can be decreased by generating additional data for training from dataset using combinations with repetitions to produce multi-sets of an original data set. Further, in an example, a confidence level can be increased utilizing input signals from other components of HMI 112 of vehicle 102. For example, responsive to operator 205 interacting with an infotainment component of vehicle 102, which can be validated utilizing input signals from the infotainment component, can also be validated to increase predictions or confidence levels of nodal model 250. In some examples, input from torque sensors and/or capacitive sensors can be used to modify confidence level and/or support machine learning techniques. In another example, a first nodal model could be generated utilizing features extracted from images captured by camera 210 and from a second camera having (typically overlapping but not identical) fields of view including the interior of vehicle 102. Nodal models resulting from programming of computer 104 extracting features captured by camera 210 and from the second camera could enhance confidence in the prediction of the position of the hands of operator 205.

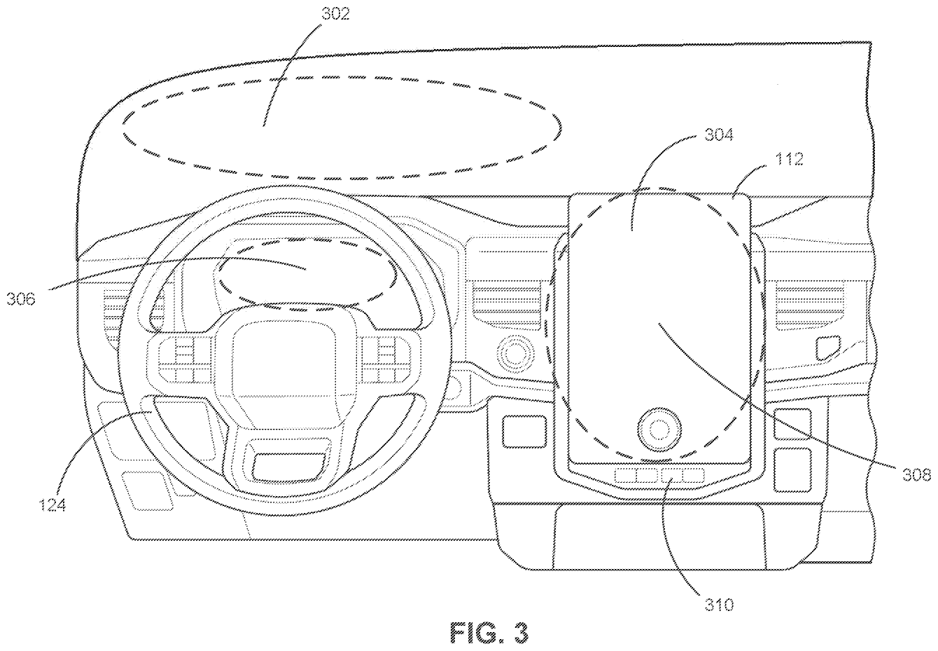

In an example, eye gaze direction 220 can be determined using eye tracking, gaze estimation, facial recognition, and/or other suitable algorithms, including those conventionally known. Eye gaze direction can be characterized according to a line or ray that can be determined to have an angle with respect to a forward direction 150 and/or that can be determined to be within a forward direction 150, e.g., when mapped to zones on the windshield and/or dashboard with a look-up table, for example. The zones e.g., 302, 304, and 306 can correspond to a direction with respect to the vehicle 102. As shown in FIG. 3, the operator's eye gaze direction 220 can be mapped to different zones including forward directions, such as the windshield 302 and instrument cluster 306 as well as non-forward directions such as HMI zone 304. In the example depicted in FIG. 2A, operator 205 appears to have an eye gaze direction 220 away from the forward direction 150 in order to view HMI 112 in zone 304. HMI zone 304 can include the HMI 112 for an infotainment display, a vehicle navigation system, and/or a communication system, etc. The HMI can include a touch screen display 308 and/or buttons 310, etc. In some examples, the operator's eye gaze direction and/or corresponding zone can be provided by a vehicle driver state monitoring (DSM) system.

Although the nodal model and eye gaze direction are shown and described with respect to an operator of the vehicle, these techniques can also be applied to the front seat passenger of the vehicle. The passenger can be monitored to determine e.g., whether the passenger's eye gaze direction is toward the HMI and whether the location of the passenger's hand is in contact with the HMI. In some examples, the nodal model can be used to differentiate between the operator's hands and the passenger's hands based on e.g., size. In addition, the hands can be differentiated based on other characteristics such as hair, skin tone, jewelry, freckles, etc.

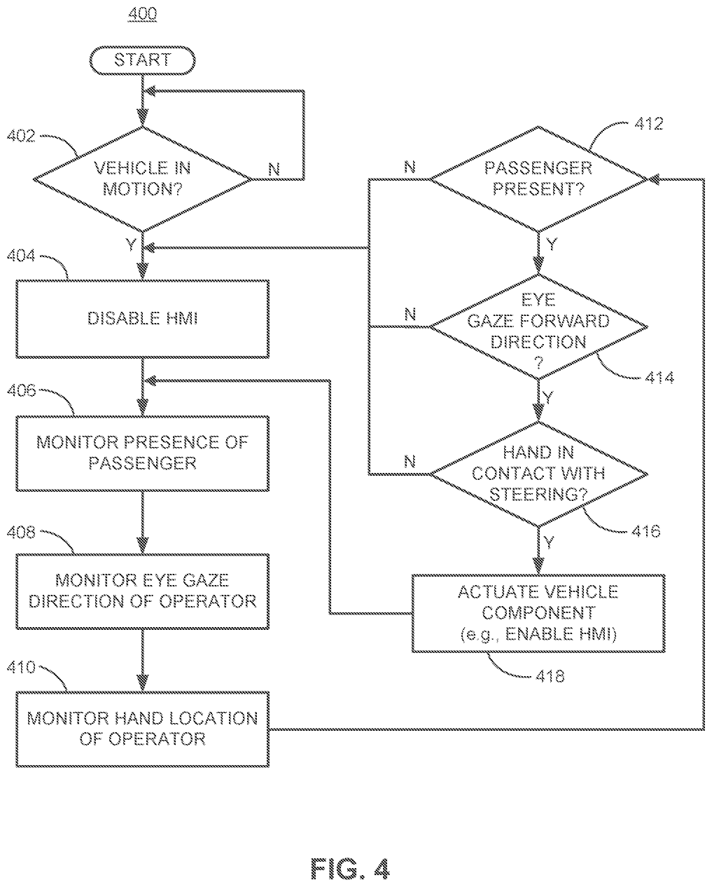

FIG. 4 is a process flow diagram 400 illustrating an example process for controlling vehicle components, features, and/or systems in response to determining whether an operator's hands are in contact with a vehicle steering wheel 124 and the operator's gaze is in a forward direction with respect to the vehicle 102, e.g., toward the road. Process 400 can be implemented in a computer 104 included in a vehicle 102. Process 400 includes multiple blocks that can be executed in the illustrated order. Process 400 could alternatively or additionally include fewer blocks or include the blocks executed in different orders.

Process 400 can begin at decision block 402, such as in response to vehicle 102 being placed into an ON state, or in a “drive” state to operate on a roadway, for example. At block 402, the computer 104 can determine if the vehicle 102 is in motion. For example, the computer can monitor a speed of vehicle 102. In response to a determination at decision block 402 that the vehicle is in motion, e.g., vehicle speed is greater than zero, process 400 can proceed to block 404. Otherwise, the process 400 can return to decision block 402 to monitor if the vehicle is in motion.

At block 404, the computer 104 can disable an HMI for an infotainment display, a vehicle navigation system, and/or a communication system, for example. Alternatively, the system can disable specified features of the HMI, including typing input, such as an address or a search string.

Process 400 may continue at block 406, which can include computer 104 monitoring for the presence of a passenger. Specifically, the computer 104 can monitor the passenger side occupancy sensor 122 for presence of a front seat passenger.

Process 400 may continue at block 408, which can include computer 104 monitoring an eye gaze direction of the operator. Computer 104 may determine eye gaze direction 220 using facial recognition, or other suitable algorithms. Eye gaze direction can be characterized as a gaze angle (e.g., between the forward direction 150 and a ray corresponding to the eye gaze direction 220) which can be mapped to zones on the windshield and/or dashboard. The operator's eye gaze direction 220 can be mapped to zones including forward directions and non-forward directions such as HMI zone 304.

Process 400 may continue at block 410, which can include computer 104 monitoring hand locations of the operator. Block 410 can include dashboard mounted camera 210 capturing an image of a vehicle 102 interior that may include operator 205, in which the captured image may exclude certain features, e.g., the forearms and hands of operator 205. The image is then processed to form a nodal model and to estimate locations of features excluded from the camera's field of view. For example, the computer 104 can estimate locations of the operator's left and right hands to determine if the operator's hands are located on the steering wheel or otherwise.

Process 400 may continue at decision block 412, which can include the computer 104 determining whether a passenger is present. In response to a determination at decision block 412 that a passenger is present, process 400 may proceed to decision block 414. Otherwise, the process 400 returns to block 404 where the HMI is disabled, or remains disabled, and the system continues to monitor the status of the passenger and operator i.e., as described concerning blocks 406-416. In an example, in response to a determination at decision block 412 that a passenger is not present the computer 104 can actuate or generate a message to operator 205 via HMI 112 notifying the operator that the disabled HMI, or a disabled feature of the HMI, is only available when a passenger is present.

At decision block 414 the computer 104 can determine whether the operator eye gaze direction is in a forward direction. In response to a determination at decision block 414 that the operator eye gaze direction is in a forward direction, process 400 may proceed to decision block 416. Otherwise, the process 400 returns to block 404 where the HMI 112 is disabled, or remains disabled, and the system continues to monitor the status of the passenger and operator i.e., blocks 406-416. In an alternative example, the computer 104 can determine whether the operator eye gaze direction is not in the direction of the HMI 112. In response to a determination that the operator eye gaze direction is not in the direction of the HMI 112, process 400 may proceed to decision block 416.

At decision block 416 the computer 104 can determine whether one or more of the operator's hands are in contact with the steering wheel. In an example, the computer can determine that both of the operator's hands are on the steering wheel or that at least the hand nearest the HMI is in contact with the steering wheel. In response to a determination at decision block 416 that at least the hand nearest the HMI is in contact with the steering wheel, process 400 may proceed to block 418. Otherwise, the process 400 returns to block 404 where the HMI is disabled, or remains disabled, and the system continues to monitor the status of the passenger and operator i.e., blocks 406-416. In an alternative example, the computer 104 can determine whether the operator's hands are not in contact with the HMI. In response to a determination that the operator's hands are not in contact with the HMI, process 400 may proceed to block 418.

At block 418 when computer 104 has determined that a passenger is present (block 412), the eye gaze direction is toward or in a forward direction (block 414), and that at least the hand nearest the HMI is in contact with the steering wheel (block 416), the computer 104 can enable the HMI. After block 418 the system continues to monitor the status of the passenger and operator i.e., blocks 406-416.

In an example, the process 400 can include monitoring an eye gaze direction of the passenger based on an image of the passenger and monitoring the locations of the passenger's hands based on the image of the passenger. In addition to requiring that the passenger be present in order to enable the HMI, the system can additionally require that the passenger's eye gaze direction is toward the HMI, e.g., an axis of the eye gaze intersects a surface of the HMI, and that the location of at least one of the passenger's hands is in contact with the HMI. Thus, in an example, the system only enables the HMI in response to determining that the passenger is present, the location of the operator's hand is in contact with a steering element of the vehicle, the operator's eye gaze direction is toward or in a forward direction with respect to the vehicle, the passenger's eye gaze direction is toward the HMI, and the location of the passenger's hand is in contact with the HMI.

In an alternative example, the computer 104 can output a command to control a subsystem or component 110 including steering, braking, and/or propulsion of the vehicle 102, e.g., to steer and/or slow the vehicle 102 in response to determining that an operator's hands are not in contact with the steering wheel and/or the eye gaze direction is away from a forward direction. For example, the computer 104 can actuate a steering component when the location of the hand is not in contact with a steering element of the vehicle and the eye gaze direction is away from a forward direction with respect to the vehicle.

Operations, systems, and methods described herein should always be implemented and/or performed in accordance with an applicable owner's/user's manual and/or safety guidelines.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

In the drawings, the same reference numbers indicate the same elements. Further, some or all of these elements could be changed. With regard to the media, processes, systems, methods, etc. described herein, it should be understood that, although the steps of such processes, etc. have been described as occurring according to a certain ordered sequence, unless indicated otherwise or clear from context, such processes could be practiced with the described steps performed in an order other than the order described herein. Likewise, it further should be understood that certain steps could be performed simultaneously, that other steps could be added, or that certain steps described herein could be omitted. In other words, the descriptions of processes herein are provided for the purpose of illustrating certain examples and should in no way be construed so as to limit the claims.

The adjectives first and second are used throughout this document as identifiers and, unless explicitly stated otherwise, are not intended to signify importance, order, or quantity.

The term exemplary is used herein in the sense of signifying an example, e.g., a reference to an exemplary widget should be read as simply referring to an example of a widget.

Use of in response to, based on, and upon determining herein indicates a causal relationship, not merely a temporal relationship.

Computer executable instructions may be compiled or interpreted from computer programs created using a variety of programming languages and/or technologies, including, without limitation, and either alone or in combination, Java, C, C++, Visual Basic, Java Script, Perl, Python, HTML, etc. In general, a processor e.g., a microprocessor receives instructions, e.g., from a memory, a computer readable medium, etc., and executes these instructions, thereby performing one or more processes, including one or more of the processes described herein. Such instructions and other data may be stored and transmitted using a variety of computer readable media. A file in a networked device is generally a collection of data stored on a computer readable medium, such as a storage medium, a random-access memory, etc. A computer readable medium includes any medium that participates in providing data e.g., instructions, which may be read by a computer. Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

What is claimed is:

1. A system, comprising:
a computer including a processor and a memory, the memory storing instructions executable by the processor to:
determine a presence of a passenger;
determine an eye gaze direction of an operator based on an image of the operator;
determine a location of a hand of the operator based on the image of the operator; and
actuate a vehicle component based on the determined presence of the passenger, the determined eye gaze direction of the operator, and the determined location of the hand of the operator.

2. The system of claim 1, wherein the vehicle component is a steering component of a vehicle and wherein the instructions further include instructions to actuate the steering component when the location of the hand is not in contact with a steering element of the vehicle and the eye gaze direction is away from a forward direction with respect to the vehicle.

3. The system of claim 1, wherein the vehicle component is a human machine interface (HMI) of a vehicle and wherein the instructions further include instructions to enable the HMI when the passenger is present, the location of the hand is in contact with a steering element of the vehicle, and the eye gaze direction is in a forward direction with respect to the vehicle.

4. The system of claim 3, wherein the instructions further include instructions to disable the HMI when the location of the hand is not in contact with the steering element of the vehicle or the eye gaze direction is not in the forward direction.

5. The system of claim 1, wherein the instructions to determine an eye gaze direction include instructions to utilize the image of the operator to determine a gaze angle and map the gaze angle to a direction with respect to a vehicle.

6. The system of claim 1, wherein the instructions to determine a location of a hand of the operator include instructions to utilize the image of the operator to construct a nodal model of the operator.

7. The system of claim 1, wherein the instructions further include instructions to determine an eye gaze direction of the passenger based on an image of the passenger and determine a location of a hand of the passenger based on the image of the passenger.

8. The system of claim 7, wherein the vehicle component is a HMI of a vehicle and wherein the instructions further include instructions to enable the HMI when the passenger is present, the location of the operator's hand is in contact with a steering element of the vehicle, the operator's eye gaze direction is in a forward direction with respect to the vehicle, the passenger's eye gaze direction is toward the HMI, and the location of the passenger's hand is in contact with the HMI.

9. The system of claim 8, wherein the instructions further include instructions to disable the HMI when the passenger is not present.

10. The system of claim 8, wherein the HMI is a vehicle navigation system.

11. A method, comprising:
determining a presence of a passenger;
determining an eye gaze direction of an operator based on an image of the operator;
determining a location of a hand of the operator based on the image of the operator; and
actuating a vehicle component based on the determined presence of the passenger, the determined eye gaze direction of the operator, and the determined location of the hand of the operator.

12. The method of claim 11, wherein the vehicle component is a steering component of a vehicle and further comprising actuating the steering component when the location of the hand is not in contact with a steering element of the vehicle and the eye gaze direction is away from a forward direction with respect to the vehicle.

13. The method of claim 11, wherein the vehicle component is a human machine interface (HMI) of a vehicle and further comprising enabling the HMI when the passenger is present, the location of the hand is in contact with a steering element of the vehicle, and the eye gaze direction is in a forward direction with respect to the vehicle.

14. The method of claim 13, further comprising disabling the HMI when the location of the hand is not in contact with the steering element of the vehicle or the eye gaze direction is not in the forward direction.

15. The method of claim 11, wherein determining an eye gaze direction includes utilizing the image of the operator to determine a gaze angle and map the gaze angle to a direction with respect to a vehicle.

16. The method of claim 11, wherein determining a location of a hand of the operator includes utilizing the image of the operator to construct a nodal model of the operator.

17. The method of claim 11, further comprising determining an eye gaze direction of the passenger based on an image of the passenger and determining a location of a hand of the passenger based on the image of the passenger.

18. The method of claim 17, wherein the vehicle component is a HMI of a vehicle and further comprising enabling the HMI when the passenger is present, the location of the operator's hand is in contact with a steering element of the vehicle, the operator's eye gaze direction is in a forward direction with respect to the vehicle, the passenger's eye gaze direction is toward the HMI, and the location of the passenger's hand is in contact with the HMI.

19. The method of claim 18, further comprising disabling the HMI when the passenger is not present.

20. The method of claim 18, wherein the HMI is a vehicle navigation system.
